(19) United States
(12) Patent Application Publication
(10) Pub. No.: US 2006/0167572 A1
(43) Pub. Date: Jul. 27, 2006

(54) Device for controlling a plurality of lamps

(75) Inventor: Holger Fluss, Remscheid (DE)

Correspondence Address: THE FIRM OF KARL F ROSS, 5676 RIVERDALE AVENUE, PO BOX 900, RIVERDALE (BRONX), NY, 10471-0900, US

(73) Assignee: ERCO Leuchten GmbH

(21) Appl. No.: 11/108,004

(22) Filed: Apr. 13, 2005

(30) Foreign Application Priority Data
Apr. 15, 2004 (DE) 102004018804.1

(51) Int. Cl. G05B 15/00

(52) U.S. Cl. 700/83

(57) ABSTRACT

Described and shown is a device (10) for controlling a plurality of luminaires (11a, 11b, 11c) with a common signal line (13) which connects the luminaires together, at least one service unit (20) at which control commands can be issued by a user for the luminaires and at least one memory unit connected with the signal line for illumination information.

The significance is that at least one luminaire has at least three differently colored light sources, for example a red lamp, a blue lamp and a green lamp, whereby each of the three lamps has its own individually addressable switching device with which the brightness level of the respective lamp is adjustable. An input device (15) is provided at which at least one color value (Z) for the luminaires can be inputted and whereby a computer unit (16a, 16b) is provided which calculates the brightness level value of the three lamps for the inputted color value and whereby the computer unit for displaying the color value with the luminaires individually addresses the switching device and sends the brightness level values to them.

The invention relates to a device for controlling a plurality of lamps according to the preamble of claim 1.

Such a device from the applicant is also known from DE 198 17 073.4. In the known device the addressing of the individual lamps is effected over a LON-bus. The known device has been found to be satisfactory in use.

The known device is further developed in accordance with the objects of the invention by making it more versatile.

This object is achieved in accordance with the invention by the features of claim 1, especially those of its characterization clause and the invention is thus characterized in that at least one lamp or luminaire has at least three differently colored light sources, for example, a red lamp, a blue lamp and a green lamp, whereby each of the three lamps has its own individually addressable switching device associated with and connected to it and with which the respective brightness levels of the respective lamps are adjustable, whereby an input unit is provided into which at least one color value for the lamps can be registered or recorded and whereby a computer unit is provided which calculates for a given color value the brightness level values required for the three light sources, whereby the computer unit connected to display the color value by the lights transmits the color level values to the individual addresses of the switching devices.

The principle of the invention resides initially in generating differently colored lights. For this purpose luminaires are provided which each comprise a plurality of differently colored partial lamps or light sources, for example, a red, a green and a blue partial lamp. As light sources, for example, colored fluorescent lamps although optionally other light sources, for example LEDs, can be considered.

As differently colored lamps, white lamps and those colorless lamps can be considered within the definition which cooperate with a color-imparting element, for example, a color filter, for instance a color film.

The color produced by a lamp is thus the sum of the individual colors. Depending upon the brightness level of the individual light sources, the different overall or total color produced by a lamp can be determined.

A special feature of the invention is that each individual lamp or luminaire has an individually addressable switching device assigned to the individual lamp. The switching device can be a separate component for each individual lamp or alternatively can be a component common to a plurality of different lamps which enable individual addressing possibilities for the three light sources.

The device is also provided with an input unit which can be used to input a color value for the luminaire. The input color value should be displayed by the luminaire by corresponding calculation of the brightness levels of the individual lamps and by transmitting these brightness level values to the switching devices. For this purpose the computer unit will calculate the brightness level values required from the three lamps to produce the input color value. The computer unit then sends the brightness level values to the individual addresses of the switching device for display of the color value.

The invention enables initially the input of defined color values at the input unit. In addition, the device enables especially simple transmission of the brightness level values to the switching devices. The device according to the invention enables the use of the DALI-protocol for the communication between memory units and the switching device. The DALI-protocol is described in the appendix E of Standard IEC 60929 for switching devices [electronic control gear or ECG of a DALI system]. Further information can be obtained from the web site of the DALI Association at www.dali-ag.org. The contents of the DALI Handbook, second edition, which can be downloaded from that web site is here included by reference in the instant patent application.

The DALI-protocol is not designed or provided for the control of colored luminaires. Nevertheless the device of the invention enables the use of the DALI-protocol for color changes of luminaires. Especially it can be noted in this connection that the computer unit for displaying the color value, transmits the brightness level value directly and by individual addressing to the switch devices. A lookback to the light scene memory in the individual switching devices as provided for calling forth light scenes in accordance with the DALI-protocol is not required. The direct individually addressable transmission of the brightness level values allows by contrast a very high degree of variability.

The computer unit can be comprised for example of two computer unit parts which are respectively associated with the memory unit and the input unit. It is especially advantageous when the computer unit part associated with the input unit can perform a portion of the calculation, computation or computer work, for example during signal input and when the second computer unit part associated with the memory unit is assigned the task of transmitting the control information to the individual switching devices, especially when in addition, the input unit is separated from the device.

A singular addressing of the switching device in the sense of the invention means that the transmission of the brightness level value in each case is to a certain individual and specified switching device and thus to a certain subscriber or participant unit of the network and especially to a lamp of a certain color. The command to display the color value by the luminaire is sent by the computer unit and/or by the memory unit and thus always contains an address component.

A device for controlling a plurality of luminaires is known under the name “LUXMATE-Emotion” and derives from the zumetobel-Staff GmbH located at Dornbirn, Austria. With this device, color values can be inputted at a service unit. A calculation of the brightness level values from the color values follows and the brightness level values, individually addressed as light scenes, are stored in electronic switching devices. The device thus uses the possibilities available with the DALI-Protocol to store light scenes. For the display of the color value, commands are sent via the signal lines to the luminaires to call up the stored light scene. For the display of the color value by the luminaire, brightness level values are not transmitted directly and individually addressed to the lamps thereof. The known device does not permit an input of more than two color values and especially does not allow for optional selection of a sequence of color states. In addition a real time display and thus color outputs of color values supplied by the input unit on a real time basis is not possible with the known apparatus. In addition because the number of command sets which can be used with the DALI-Protocol is limited, the number of possible light scenes or statistically stored color states is limited to 16.

According to a further feature of the invention, the user can select the time (target time) at which the luminaire is to output a different color value from a previously outputted color value. In a real time mode this target time can also be close to zero. The input unit thus makes it possible for the user to set a target time at which time there will be a changeover of the color produced by the luminaire to the new value.

The target time which is adjustable by the user can also be a cycling time which is required for the passage through a color process involving a number of color states or stations. The target time is in this sense, for example, the total cycling time of the color process. If for example a target time of 500 seconds is preestablished to run through 10 different color stations, the time interval between two color stations, adjustable by the user will be 50 seconds.

According to a further advantageous feature of the invention, the computer unit and/or the memory unit subdivides the target time into a plurality of time intervals (fading time). The computer and/or the storage unit calculate between the starting color value and another color value a corresponding number of intermediate color values and intermediate brightness level values associated therewith. They then send the calculated intermediate brightness level values and the brightness level values corresponding to the color values to respective individual addresses of the switching devices in the time intervals. This aspect of the invention affords special advantages with respect to color transitions. From a starting color value displayed by the luminaire at a starting time point, the user can input a color value that the lamp will assume at a target time point and the luminaire can change the colors in a predetermined manner to reach the target value within a target duration.

If one wishes to transmit to the switching device only the brightness level value corresponding to the color value and if one desires a transition from the starting color value to a later color value within the target period, one can use the DALI-protocol to send the target color value only to the switching device and can employ the fading time stored in the switching device. There is a problem with this approach, however, in that in different switching devices, different dimming curves for the emitted light currents or lumen output can be stored. This means that within certain selected fading times, the control curves for switching the dimming state of the lamps is different in different switching devices. In order to achieve clean, clear and precise color transitions, with this aspect of the invention a number of intermediate values and intermediate stages can be calculated used for control purposes to effect control within each short time interval. The steps can be so shortened in this manner that for the production of a color transition, the dimming curve stored in each individual switching device is no longer approached. The dimming curve can in this sense no longer be considered.

It is especially advantageous when the time intervals are made shorter than 10 seconds, advantageously shorter than 5 seconds and especially preferably shorter than 2 seconds. Color transmissions with such short time intervals can practically no longer be resolved by the human eye because of the reduced spacings of the color changes.

According to another advantageous feature of the invention, the input unit can be provided in a device which is separate from the service or operating unit. This enables the service or operating unit to be a device which is used by the end user practically only to generate control commands or to call up the control command which the end user can output. The significantly more complicated input unit, which for example may be utilized by or serviced by the light planner, can be a separate component, especially a component of a computer. The service or operating unit can in this case be of very simple configuration capable of being fabricated at low cost. The significant requirement for storage capacity and performance can thus be confined to the memory unit.

According to a further advantageous feature of the invention, the input unit is associated with a color value display for (substantially) all color values which can be produced and from which color value display, the color value to be outputted by the luminaires can be selected. The color value display can, for example, be a color circle or a standard color table which can show all of the luminaire generatable colors. A special problem in this connection is that the color displayed on an image screen may not precisely correspond with the color that the luminaire produces in the illuminated space. With the device according to the invention, the outputting of the color value by the luminaires can be controlled in the installed state.

For this purpose in an embodiment of the invention the color value selection is made by a cursor which can be controlled by a positioning device, for example a mouse and which moves over the color value display and can vary the cursor location. The cursor location signals the computer unit and/or the memory unit as to the color selection. In this manner it is possible to directly select a color value from the color value display, that is in approximately real time and, if appropriate on line, to control the luminaire as to the color value outputted thereby.

According to a further advantageous feature of the invention, the color value is calculated by the computer from the cursor location on line and outputted by the luminaire. In this manner a positioning of the cursor, for example by a movement of the mouse, suffices to vary the color. A mouse click is no longer required in this embodiment of the invention.

According to an alternative embodiment of the invention, for calculating the color value from the cursor position, the actuation of an actuating element is required, for example, the left mouse button. This enables a definite and reliable signaling of a choice of the color value for and by the input unit.

According to a further advantageous feature of the invention, an input unit can have a plurality of color values (color stations) inputted therewith. The plurality of color values can be combined by the user in an optional sequence. It is possible for example to provide a color process which passes through the color stations red-green-red-blue-red-yellow-red-green-red-orange-red-blue-red-violet-red-blue-red-green-red-orange etc. Advantageously, the input unit can request an input from the user of a number of color values. The combination of the color values leads to a color process or procedure. This procedure can be cycled in an endless manner for the generation of a corresponding endless loop of dynamic illumination which can be programmed into or by the input unit.

Preferably the information (brightness level values) as to the color process can be stored in the memory unit and can be called up therefrom. The ability to call up a process from memory is also provided for the service unit. The color process for color stations which are initially provided in the input unit by a light planner can thus be called from memory in a very convenient way.

According to a further advantageous feature of the invention, the memory unit and/or the computer unit transmits the corresponding brightness level value for display of the color process, i.e. outputting of the color process by the luminaire, one after another as individually addressed to the respective switching devices. Such a transmission process can be effected during the normal operation of the device, for example, with a corresponding selection from a menu which has been made at the service unit. Alternatively, the transmission process can be effected also during a programming phase of the device at a point in time at which the input device is connected with the luminaire apparatus. This embodiment enables inputting of an optional selection of color stations of a color process wherein however the storage availability of light scenes provided in the DALI-Protocol and limited to 16 need not be of concern.

According to a further advantageous feature of the invention the switching devices communicate with the memory unit land/or with at least one art of the computer unit using the DALI-Protocol. This enables a compatibility of different switching devices with one another. Of course other known standards can be considered and used as well.

According to a further advantageous feature of the invention, the signal line can be provided with an interface, especially a USB-interface. With such an interface, a computer, especially a lap top, can be connectable to the device in a simple manner. The interface can be arranged according to a further feature of the invention on a housing for the service unit. This simplifies accessability.

For this purpose the interface in a mounted state of the service unit, especially in a wall-mounted state of the service unit can be freely accessible on the housing and especially can be arranged on an underside thereof.

Further advantages of the invention are given in the dependent claims which have not been cited as well as in the following description of an embodiment illustrated in the Figures. These show:

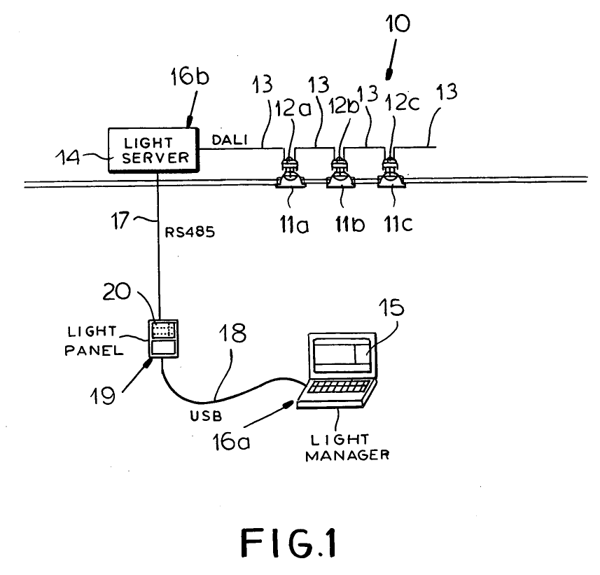

FIG. 1 in a schematic block diagram the structure of the device according to the invention,

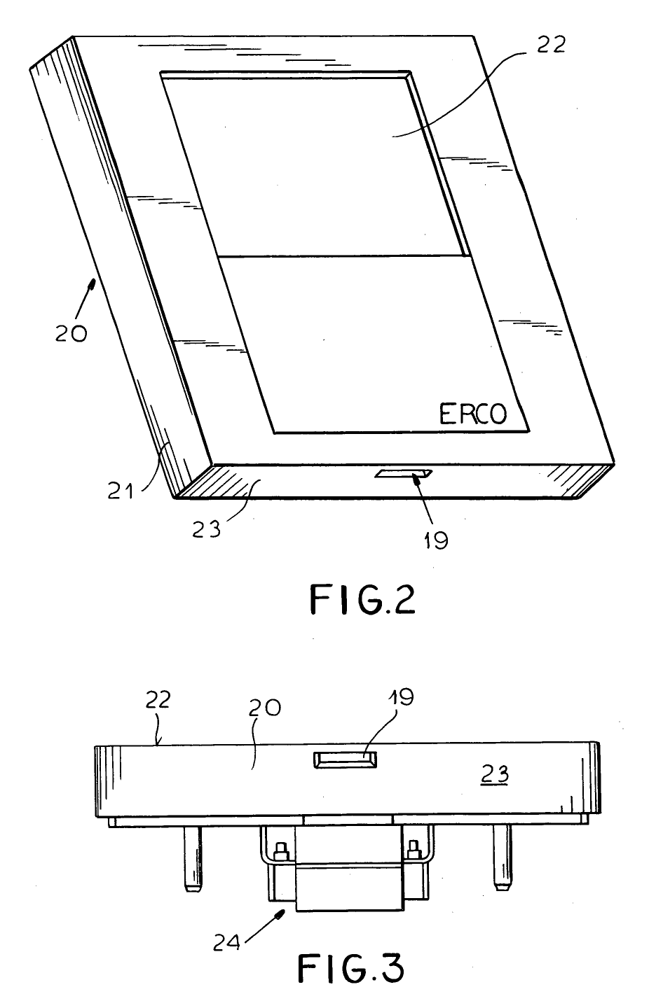

FIG. 2 in a perspective view the service unit,

FIG. 3 in a bottom view in the direction of the arrow III in FIG. 2, the service unit of FIG. 2, and

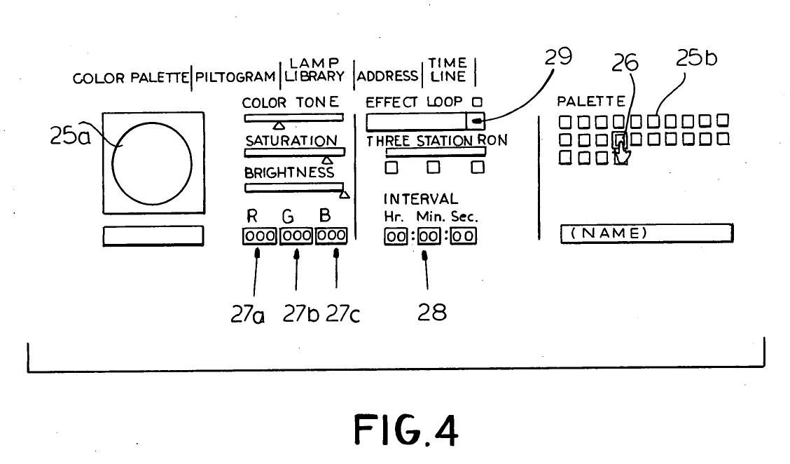

FIG. 4 a color value display as well as further input possibilities on the screen of an input unit.

The device shown at 10 in its totality in FIG. 1 has only been illustrated by way of example in the drawing. According to FIG. 1 the device encompasses three luminaires 11a, 11b and 11c which are built into a building, for example, in a roof or ceiling. Each individual luminaire, for example the luminaire 11a, comprises differently colored individual lamps, not shown, especially a red lamp or light source, a green lamp or light source and a blue lamp or light source. Each individual lamp of a luminaire has its own electronic switching device individual thereto and individually addressable. Consequently the luminaire 11a which comprises three individual lamps, has a group 12a of three individual, individually addressable switching devices. It is conceivable that each switching device for each individual lamp will have its own housing. For this purpose, reference may be made for example to the DALI switching devices (electronic control gear) of the firms Osram, Tridonic or Philips and which are commercially available. Alternatively it is also possible to assemble a plurality of individually addressable switching devices to a common component. What is important is that each individual lamp of the respective luminaires 11a, 11b and 11c be individually addressable over the corresponding switching device.

The three luminaires illustrated are to be understood as an example. The maximum number of subscribers or participants in the network is limited with the DALI-Protocol to 64 whereby a luminaire producing colored light will include three lamps and thus three subscribers or participants. The network can aside from colored luminaires can, as will be self-understood, additionally have also conventional single color luminaires.

The individual switching devices are connected by a common signal line 13 with a storage or memory unit 14. The memory unit 14 serves as a controller for the network and can transmit commands to the switching devices in accordance with the DALI-Protocol. The individual switching devices, which have been indicated only schematically in FIG. 1, understand the control commands transmitted from the memory unit 14 over the signal line 13 in accordance with the DALI-Protocol and translate the received information into control information for the individual lamp. Especially the electrical switching devices produce different control voltages for the individual lamps in order to apply different dimming values and thus different brightness level values individually thereto. For the case in which for example the luminaire 11a has a red, a green and a blue fluorescent lamp, the color value of a luminaire 11a can be achieved by changing he brightness levels of the individual lamps and changing thereby the overall light color.

The memory unit 14 is connected by a line 17 with a service unit 20. The service 20 communicates with the memory unit 14 through a protocol different from the DALI-Protocol and in accordance with the RS485-Standard. Control commands and information stored in the memory unit 14 can be called up through the service unit 20. For the case in which a certain light scene stored in the memory unit 14 is to be called up from memory, the service unit 20 can effect the call up. The light scene can be, for example, a static light scene so that a constant color is produced. It can however also be a dynamic scene which is recalled from storage in the memory unit 14, for example in the form of an endlessly recycling color process which passes through a plurality of color stations.

The service unit 20 has been illustrated schematically in a perspective view in FIG. 2. It should be clear that the service unit 20 has a substantially peripheral frame 21 which bounds a display 22, in the form of an image display screen. The display 22 is formed as a touch screen display so that by contact with the display, a circuit can be activated to call up the control commands for and from the memory unit 14.

On the underside 23 of the frame 21 of the service 4 unit 20, a jack is provided. This can be a USB interface 19 which can receive the cable indicated at 18 in FIG. 1. The fastening elements 24 shown schematically in FIG. 3 on the backside of the service unit 20 enables wall mounting of the service unit, especially in the region of a concealed socket or box. In the wall-mounted state of the service unit 20, the USB interface 19 is immediately accessible.

FIG. 1 shows that an input element 15, especially a portable computer (laptop) can be connected by the cable 18 with the service unit 20. The function and mode of operation of the input unit 15 will be described subsequently. First, however, it should be noted that the memory unit 14 can likewise have a USB interface 19 which has not been shown in FIG. 1, enabling its connection with the input unit 15.

As an alternative to the use of a USB interface, other interfaces can be considered. A USB interface, however, is especially convenient with respect to servicing.

FIG. 4 shows by way of example a first color value display 25a in the form of a color circle and a second color value display 25b in the form of a color pallet. Using a cursor 26 in the color value display 25b and in the form of a stylized hand with an outstretched index finger, such as a conventional cursor for Windows programs, a color value can be selected from the color spectrum. The device functions as follows:

The memory unit 14, the luminaires 11a, 11b, 11c, the individual electronic switching devices (for example the group 12a, 12b, 12c of switching devices) and the service unit 20 are all mounted in a structure. Through the USB interface 19, the device 10 consisting of all of the aforementioned elements is connected with the input unit 15. The input unit has a color value display for all, at least for substantially all of the color values which can be generated by the device 10. By way of example, the color circle 25a has been shown in FIG. 4 and encompasses the entire color spectrum.

A cursor which has not been shown in the color table 25a can be displaced along the color circle. Through the software which is running in the input unit 15 or can be called up thereby or which alternatively can be replaced by hard wiring between a unit correlating the actual location of the cursor in the color circle with a color value, a color value can be selected. The color value can, for example, as has been illustrated by the fields 27a, 27b and 27c in FIG. 4, also be displayed in the form of scale components as a red value, a green value and a blue value. For example, for each of the three colors 256 scale units can be provided for which the scale value of zero for example, represents a completely shut-off state of the red lamp and the scale value 255 a maximum output state of the red lamp. The intermediate values correspond to various dimming states. What is important is that the input unit 15 by means of a computer unit 15a determines an actual color value which is selected by the cursor location. The computer unit 16a sends this color value through the cable 18 to the service unit 20 and thus via the cable unit 17 to the memory unit 14 or to a computer component 16b forming part of the memory unit 14. The computer unit 16a and 16b can be considered part of a computer or form together the latter computer unit.

The color value received by partial computer unit 16b is converted thereby from a color value to the brightness level values for the individual lamps forming parts of the entire light generating capacity of the respective luminaires and the brightness level values are sent directly to the respective individual switching devices. It is thus possible for a color value selected by a cursor location in the color value display is thus approximately in the real time outputted by all of the luminaires 11a, 11b, 11c of the device 10. In this manner the colors selected at the input unit 15 in the framework of light planning can be directly monitored with respect to the spatial effects. An outputting of a color value which is selected by the input unit 15 is possible practically in real time and thus “on line”. To review, using the Dali-protocol, a maximum of 64 participants or subscribers or units can be provided for the device 10. In the case of color-outputting luminaires, this means a maximum of 21 luminaires which with three individual differently colored lamps.

Should all of the individual lamps be addressed at the standard transmission rates using the DALI-protocol, the total response time is 1.6 seconds. The interval, therefore, between a selection of a color value in the color value table and the illumination by the luminaires of the device of the space to be limited with this color value is then effected in this sense with a delay of about 1.6 seconds.

The thus described possibility of online or real time monitoring of a selected color enables an instantaneous relationship between the architectural requirements and a the light and color planning which is to match.

The device 10 according to the invention enables also a selection of setting of a number of different color stations and their combination to a color process. The number of different color stations is thus unlimited. The color stations form a color process or course which can recycle endlessly. The total recycle time is also adjustable by the user as is signified by the field 28 in FIG. 4. The number of color stations can be set for example in the field 29.

For input of a color process or course, that is a sequence of color stations, for example after the setting of the number of color stations desired by the user with the input device 15, the color stations in order can be called up and individual color values selected for the color stations. Thus for example, a color process or course of red-green-red-blue-red-orange-red-blue-red-yellow-red-violet etc. can be inputted and can be repeated an optional number of times. The total recycle time can for example with a color process or course of 16 stations, be 320 seconds. This means that between every two color stations, a time interval of 20 seconds will be provided.

The device 10 according to the invention calculates with the aid of the partial computer using 16a and/or with the aid of the partial computer unit 16b between any two neighboring color stations a number of intermediate color stations, for example 9 intermediate color stations. In this manner at about every 2 seconds, the partial computer unit 16b and 16a will generate a color course or the memory unit 14 will supply control information over the signal line 13 to all of the switching devices to produce that color course. The device 10 thus enables fine stepping and approximately continuous transmission of new brightness values within very short time intervals. This enables a precise predetermined color transition without recourse to the fading times stored in the switching devices. In this connection it can be noted that DALI terminal devices and thus switching devices operating in accordance with the DALI-protocol, typically have a memory location for a so-called “fading time” over which a target brightness level value can be achieved within the selected fading time. Since the individual switching devices, however have different stored dimming curves, a precisely predeterminable color transition using the individual dimming curve stored in the switching devices is not obtainable.

The device 10 according to the invention enables also the use of different switching devices, for example those of different manufacturers without introducing inaccuracies in the color transitions.

The device according to the invention transmits, for the case in which color changes are required, information from the partial computer unit 16b or the memory unit 14, as to new brightness values to be achieved to the switching devices at the latest every 10 seconds and preferably at the latest every 5 seconds and still more preferably at the latest every 2 seconds. In this manner the color changes can be practically no longer resolved by the human eye within this time interval. A finer setting is not required.

It is to be noted, in this conjunction, that the computer portion 16b and the memory unit 14 can be included in a common component in one embodiment, especially as a small or minicomputer.

The device of the invention thus offers the possibility of producing a color course or process as a kind of dynamic light scene because the individually adjustable nature fo the overall outputted color patterns. A user can select each single color station individually and assemble in this manner a color process and course of optional sequence and succession.

After using the input unit 15 for input of the individual color value and the inputting of the color course or process, the input unit 15 can be detached from the device 10 by disconnection of the USB interface connections 18/19. The illumination information, for example, with respect to a certain color process or course, is then stored in the memory unit 14 and can be called up by the operating unit 20. It is especially possible, through the use of the input unit 15 to assign a certain title to a given color process and course and after storage of that color process or course in the memory unit 14 to display it upon the display of the service unit 20 and then call it up directly.

How a change in the color value can be instantaneously obtained is clarified below.

Starting from a starting color value and thus an actual value state of a luminaire at a certain point in time, the starting value can be designated at A and will be understood to have been assigned the color triple value (255,0,0) referring to the brightness level value for a red-green and a blue lamp of light luminaire. The starting color value A from the luminaire is thus red light.

Let us assume from a starting color value a target color value Z is to be achieved which has the color treble value (0,255,0), the target color value then corresponds to green light since only the green lamp will be illuminated.

For the case in which the user selects the target color is value Z and the device 10 is outputting the starting color value A and is to output the target color value Z, for this purpose a target time t_{z} is selected which can be say 500 seconds. The device 10 thus has 500 seconds in which to switch over from the luminaire emitted color with the starting value A to the target color value Z. For this purpose the device 10 and especially the computer unit 16a or 16b, automatically selects a multiplicity of intermediate color values, preferably 254 intermediate color values. The device then sends every two seconds a new color value to the individual switching devices assigned to the lamps.

Starting from the starting color value A within, for example, the first two seconds, the switching device of the red lamp is addressed and given the new brightness value of 254. Simultaneously within the first two seconds the green lamp is individually addressed and given the brightness value 1.

Within the next two seconds exclusively at the red lamp, individually addressed to its switching device is the rightness level value 253 is delivered whereas the individually addressed switching device of the green lamp receives the brightness level value 2. In this manner, within the 500 seconds 250 times individual switching devices will be individually addressed and confronted with new brightness level target values.

It is significant further that the luminaires or participants in a network be able to be assembled in optional ways to groups. It is then possible for example, for a first dynamic light scene to be definable in the form of a color course or process which is applied to a first group of luminaires or network participants and a second light scene to be definable in the form of a color course or process which operates upon a second group of luminaires or participants in the network.

1. A device (10) for controlling a plurality of luminaires (11a, 11b, 11c) with a common signal line (13) which connects the luminaires together with at least one service unit (20) at which at least commands from a user can be called up for the luminaires, and with at least one memory unit (14) connected with the signal line for illumination information, characterized in that at least one of the luminaires has at least three differently colored light sources, for example a red lamp, a blue lamp and a green lamp, whereby each of the three lamps is associated with its own individually addressable switching device with which the brightness level of the respective lamp is adjustable, whereby an input unit (15) is provided at which at least one color value (Z) for the luminaires can be inputted and whereby the computer unit for the outputting of the color value (Z) by the luminaires individually addresses the switching devices and at least sends the brightness level values to the switching devices.

2. The device according to claim 1, characterized in that the color values (Z), starting with a lamp having a starting color value (A), especially before inputting of the color value (Z), is reached within a user-adjustable time (target time (t_{z})).

3. The device according to claim 2, characterized I that the computer unit and/or the memory unit subdivides the target time into a plurality of time intervals (fading times (t₁, t₁, t₃ . . . )) and between the starting color value (A) and the target color value (Z) a corresponding plurality of intermediate color values and/or associated intermediate brightness level values are calculated and the intermediate brightness level values which are calculated and the brightness level values which follow corresponding to the target color value are transmitted within the time interval and individually addressed to the switching devices.

4. The device according to claim 3, characterized in that the time interval is shorter than 10 seconds.

5. The device according to claim 3, characterized in that the time interval is shorter than 5 seconds.

6. The device according to claim 3, characterized in that the time interval is shorter than 2 seconds.

7. The device according to claim 1, characterized in that the input unit (15) is a separate device from the service unit (20).

8. The device according to claim 1, characterized in that the input unit (15) has a color value display 25a, 25b) for a plurality of color values, especially all color values which can be outputted, whereby the target color value (Z) can be selected from the color value display.

9. The device according to claim 8, characterized in that the color value display is a color circle (25a), a color pallet (25b) or a color standard table.

10. The device according to claim 8 characterized in that the color value display is provided with a cursor (26) which can be controlled by means of a positioning device, for example a mouse, to move along the color value display by changing its cursor position.

11. The device according to claim 10, characterized in that the computer unit (16a, 16b) and/or the memory unit (14) responds to the cursor position representing a color value.

12. The device according to claim 11, characterized in that the computer unit and/or the memory unit directly compute, from the color value represented by the cursor position, approximately in real time, brightness level values and transmit these directly, approximately in real time, individually addressed, to the switching devices.

13. The device according to claim 11, characterized in that the color value is calculated from the cursor position in real time.

14. The device according to claim 11, characterized in that the color value is calculated from the cursor position only after actuation of an actuating element, for example, the left-hand button of a mouse.

15. The device according to claim 1, characterized in that the input unit (15) can input a plurality of color values (color stations).

16. The device according to claim 15, characterized in that the input unit (16) can request the desired number of color values (Z) to be inputted and/or one after the other the plurality of color values (Z) from the user.

17. The device according to claim 15, characterized in that the plurality of color values (color stations) can be combined into a color process or course from the user selected sequence.

18. The device according to claim 15, characterized in that the color process is configured to recycle continuously and the recycle duration can be selected by the user.

19. The device according to claim 15, characterized in that the information (brightness level values) as to the color process can be stored in the memory unit.

20. The device according to claim 15, characterized in that the memory unit (14) and/or the computer unit (16a, 16b) sends corresponding brightness level values one after another individually addressed to the switching devices for displaying the color process.

21. The device according to claim 20, characterized in that the computer unit and/or the memory unit calculates between two color stations (A, Z) a color process or course of a plurality of intermediate brightness values and the intermediate brightness value, especially in short time intervals, are sent to the switching devices of the luminaire as individually addressed for displaying the intermediate color values by the luminaire.

22. The device according to claim 1, characterized in that the switching devices communicate by the DALI-protocol with the memory unit and/or the computer unit (16a, 16b).

23. The device according to claim 1, characterized in that the individual light sources of the luminaires can be assembled into groups.

24. The device according to claim 1, characterized in that the signal line has an interface (19) which is operatively connectable with a computer (15).

25. The device according to claim 24, characterized in that the input unit (15) is formed by the computer.

26. The device according to claim 24, characterized in that at least a part (16a) of the computer unit is formed by the computer (15).

27. The device according to claim 24, characterized in that the interface (19) is arranged on a housing of the service unit (20).

28. The device according to claim 26, characterized in that the interface (19) is freely accessible in a mounted state of the service unit (20) and especially in a wall-mounted state of the service unit.

29. The device according to claim 28, characterized in that the interface is arranged on the underside (23) of the service unit in a mounted state thereof.

30. The device according to claim 24, characterized in that the interface is a USB interface.

31. The device according to claim 1, characterized in that at least part (16b) of the computer unit and the memory unit (14) form a single component.
